(19) United States
(12) Patent Application Publication
(10) Pub. No.: US 2009/0168162 A1
(43) Pub. Date: Jul. 2, 2009

(54) Microscopy Methods And Apparatus For Manipulation And/Or Detection of Biological Samples And Other Objects

(75) Inventors: Donhee Ham, Cambridge, MA (US); Robert Westervelt, Lexington, MA (US); Thomas Hunt, Portland, OR (US); Yong Liu, Cambridge, MA (US); Hakho Lee, Cambridge, MA (US)

Correspondence Address: WOLF GREENFIELD & SACKS, P.C., 600 ATLANTIC AVENUE, BOSTON, MA, 02210-2206, US

(73) Assignee: President and Fellows of Harvard College, Cambridge, MA (US)

(21) Appl. No.: 12/087,532

(22) PCT Filed: Jan. 12, 2007
(86) PCT No.: PCT/US2007/000779

§ 371 Date: Dec. 15, 2008

Related U.S. Application Data
(60) Provisional application No. 60/759,138, filed on Jan. 13, 2006.

(51) Int. Cl. G02B 21/26; G02B 21/32

(52) U.S. Cl. 359/395

(57) ABSTRACT

Microscopy methods and apparatus for manipulation, detection, imaging, characterization, sorting and/or assembly of biological or other materials, involving an integration of CMOS or other semiconductor-based technology and microfluidics in connection with a microscope. In one implementation, a microscope including optics and a stage is outfitted with various components relating to the generation of electric and/or magnetic fields, which are implemented on an IC chip. A microfluidic system is fabricated either directly on top of the IC chip, or as a separate entity that is then appropriately bonded to the IC chip, to facilitate the introduction and removal of cells in a biocompatible environment, or other particles/objects of interest suspended in a fluid. The patterned electric and/or magnetic fields generated by the IC chip can trap and move biological cells or other objects inside the microfluidic system to facilitate viewing via the microscope.

### FIELD OF THE DISCLOSURE

The present disclosure relates generally to microscopes employing methods and apparatus for manipulating, detecting, imaging, and/or identifying particles or objects via electromagnetic fields.

### BACKGROUND

A conventional microscope is a well-known instrument for viewing objects that are too small to be seen by the naked or unaided eye. The science of investigating small objects (hereinafter alternatively referred to as “particles,” or “samples”) using such an instrument is called “microscopy.” The most common type of conventional microscope is the optical microscope, which is an optical instrument containing one or more lenses that produce an enlarged image of an object placed in a focal plane of the lens(es).

FIG. 1A illustrates an example of a conventional compound microscope. In general, the primary components of a conventional microscope include an eyepiece 10 that includes an ocular lens. The eyepiece is connected to a body tube 12 that provides a focal path to one or more objective lenses 14 that may be configured on a rotating member 16 or “nosepiece” to facilitate selection of different objective lenses (and hence different focusing powers). A stage 18 of the microscope, connected to the body tube via an arm 30, provides a platform for viewing samples of interest. The stage generally is equipped with one or more sample holders 20 for holding one or more samples on the stage. Beneath the stage, typically some type of light source 24 is provided (e.g., a mirror, a light bulb, etc.) to illuminate the sample, as well as one or more of a diaphragm, condensor or filter 22 to control various aspects of the light illuminating the sample. Also shown in FIG. 1A are coarse and fine adjustment knobs 26 and 28, respectively, for adjusting and focusing the view of a sample of interest through the eyepiece.

In biological and medical sciences, it is often useful to be able to manipulate (e.g., move or direct) a biological sample (e.g., one or more cells) along a prescribed path. Manipulation of biological systems based on magnetic fields is one conventionally used method to accomplish this task. In one conventional implementation involving magnetic fields, a small magnetic bead with a chemically modified surface can be coupled to a target biological system, such as a particular cell or microorganism. Depending on the type of coating of a given bead, and the relative sizes of the bead and the target cell or microorganism, the bead may be bound to the surface of the cell or organism (exterior coupling), or ingested by the cell or organism (interior coupling). Such a “bead-bound” sample then may be suspended in a host liquid to constitute a “microfluid,” and the suspended sample in the microfluid can then be manipulated using an external magnetic field. Devices based on this principle often are referred to as “magnetic tweezers” and have been conventionally used, for example, to trap small particles (e.g., DNA) suspended in a liquid for study.

Because magnetic fields and the magnetic beads themselves are typically biocompatible, this process is non-invasive and generally not damaging to the sample. However, conventional magnetic tweezers fail to provide individual control of multiple magnetic beads because these devices typically produce only a single field peak that may be moved; thus only a single bead or, simultaneously, a group of beads in close proximity, may be conventionally controlled within a microfluid.

Another area related to the movement and manipulation of biological samples, particles, or other objects suspended in liquid involves a phenomenon referred to as “dielectrophoresis.” Dielectrophoresis occurs when an inhomogeneous electric field induces a dipole on a particle suspended in liquid. The subsequent force on the dipole pulls the particle to either a minimum or a maximum of the electric field. Almost any particle, without any special preparation, can be trapped or moved using dielectrophoresis when it is exposed to the proper local electric field. This is an advantage of electric field-based operation over the magnetic field-based manipulation described above, as the latter mandates marking biosamples or other objects of interest with magnetic beads. However, a potential disadvantage of the dielectrophoresis is that a relatively strong electric field may damage the cell, particle or other object of interest in some circumstances.

Yet another area related to the movement and manipulation of biological samples that enables various applications in medical diagnostics and life sciences is referred to as “microfluidics.” Microfluidics is directed to the containment and/or flow of small biological samples by providing a micro-scale biocompatible environment that supports and maintains physiological homeostasis for cells and tissues. Microfluidic systems may be configured as relatively simple chambers or reservoirs (“bathtubs”) for holding liquids containing cells/biological samples of interest; alternatively, such systems may have more complex arrangements including multiple conduits or channels in which cells, particles, or other objects of interest may flow. By controlling the flow of fluids in micro-scale channels, a small quantity of samples can be guided in desired pathways within a microfluidic system. Integration of various microfluidic devices, such as valves, filters, mixers, and dispensers, with microfluidic channels in a more complex microfluidic system facilitates sophisticated biological analysis on a micro-scale. Fabrication of even some complex conventional microfluidic systems generally is considered to be cost-effective, owing to soft-lithography techniques that allow many replications for batch fabrication.

Once fabricated, however, conventional microfluidic systems (especially more complex systems) do not offer an appreciable degree of flexibility, and specifically suffer from insufficient programmability and controllability. In particular, conventional microfluidic systems that are used for analytic operations such as cell sorting are manufactured to have a specific number and arrangement of fixed channels and valves. Operation of the valves controls the flow of cells into the channels, thereby sorting them. Function of the system generally is based on a statistical approach of differentiating amongst relatively larger numbers of cells, and not sorting one cell at a time. Because the arrangement of channels and valves is determined during fabrication of the microfluidic system, each system is designed for a specific operation and typically cannot be used in a different process without modifying its basic structure.

Integrated circuit (IC) technology is one of the most significant enabling technologies of the last century. IC technology is based on the use of a variety of semiconductor materials (e.g., Silicon Si, Silicon Germanium SiGe, Gallium Arsenide GaAs, Indium Phosphide InP, etc.) to implement a wide variety of electronic components and circuits. Perhaps one of the most prevalent examples of IC technology is CMOS (Complimentary-Metal-Oxide-Semiconductor) technology, with which silicon integrated circuits are fabricated.

CMOS technology is what made possible advanced computation and communication applications that are now a routine part of everyday life, such as personal computers, cellular telephones, and wireless networks, to name a few. The growth of the computer and communication industry has significantly relied upon continuing advances in the electronic and related arts in connection with reduced size and increased speed of silicon integrated circuits, whose trend is often quantified by Moore's law. Currently, silicon CMOS chips can contain over 100 million transistors and operate at multi-gigahertz (GHz) speeds with structures as small as 90 nanometers. CMOS microfabrication technology has matured significantly over the last decades, making silicon integrated circuits very inexpensive. Despite several advantages, however, neither CMOS nor any other semiconductor-based IC technology has been widely used (i.e., beyond routine data processing functions) to implement structures for biological applications such as sample manipulation and characterization.

### SUMMARY

Applicants have recognized and appreciated that integrated circuit semiconductor-based technology (e.g., Si, SiGe, GaAs, InP, etc.), and especially CMOS technology, provides a viable foundation for the realization of systems and methods for manipulating and characterizing biological materials and other objects of interest. Applicants also have recognized and appreciated that by combining CMOS or other semiconductor-based technology with microfluidics, a wide variety of useful and powerful methods and apparatus relating to biological and other materials may be realized. Furthermore, Applicants have recognized and appreciated that such methods and apparatus would find particular utility in connection with microscopy applications, in which one or more samples of interest are viewed under a microscope or similar instrument.

In view of the foregoing, various embodiments of the present disclosure are directed to microscopy methods and apparatus for one or more of manipulation, detection, imaging, characterization, sorting and assembly of biological or other materials on a micro-scale that are being viewed under a microscope of similar instrument. In various exemplary implementations such microscopy methods and apparatus involve an integration of CMOS or other semiconductor-based technology and microfluidics.

For example, one embodiment is directed to microscope equipped with an IC/microfluidic hybrid system that combines the power of an integrated circuit chip with the biocompatibility of a microfluidic system. In one aspect of this embodiment, various components relating to the generation of electric and/or magnetic fields of such a hybrid system are implemented on an IC chip that is fabricated using standard protocols (e.g., CMOS) in a chip foundry. In another aspect, the field generating components themselves may be formed using standard CMOS protocols and hence do not require any micromachining techniques (e.g., as in micro-electro-mechanical structures, or MEMS implementations). The electric and/or magnetic fields generated from such an IC chip may be used to manipulate and/or detect one or more dielectric and/or magnetic particles that are being viewed under the microscope, and distinguish different types of particles.

In particular, in one embodiment, a microscope stage onto which one or more samples of interest are placed is outfitted with an array of microelectromagnets, or “microcoils,” which are implemented on an IC chip and configured to produce controllable spatially and/or temporally patterned magnetic fields. In one aspect, the IC chip also may include a programmable digital switching network and one or more current sources configured to independently control the current in each microcoil in the array so as to create the spatially and/or temporally patterned magnetic fields. In another aspect, the IC chip may further include a temperature regulation system to facilitate biocompatibility of the hybrid system.

In another embodiment, a microscope stage onto which one or more samples of interest are placed is outfitted with an array of microelectrodes, or “microposts,” which are implemented on an IC chip and configured to produce controllable spatially and/or temporally patterned electric fields to manipulate particles of interest based on dielectrophoresis principles. In one aspect, the IC chip also may include a programmable digital switching network and one or more voltage sources configured to independently control the voltage across each micropost in the array so as to create the spatially and/or temporally patterned electric fields. As in the previous embodiment, in another aspect, the IC chip may further include a temperature regulation system to facilitate biocompatibility of the hybrid system.

In yet another embodiment, an array of microcoils implemented on an IC chip, which is then disposed in or on a microscope stage (e.g., affixed to or integrated with a microscope stage) may be configured to produce both controllable, spatially and/or temporally patterned, electric fields and/or magnetic fields. In one aspect, the IC chip also may include a programmable digital switching network, together with one or more current sources and one or more voltage sources, configured to independently control the current in and voltage across each microcoil in the array to create the spatially and/or temporally patterned magnetic fields and electric fields. In another aspect of this embodiment, the microcoils effectively act as microposts when a voltage is applied across them, thereby functioning to manipulate particles of interest based on dielectrophoresis principles as in the previous embodiment. Again, the IC chip according to this embodiment may further include a temperature regulation system to facilitate biocompatibility of the hybrid system.

In connection with any of the foregoing embodiments related to electric and/or magnetic field generation for sample manipulation or detection in microscopy applications, according to yet another embodiment of the present disclosure, a microfluidic system may be fabricated either directly on top of the IC chip, or as a separate entity that is then appropriately bonded to the IC chip, to facilitate the introduction and removal of cells in a biocompatible environment, or other particles/objects of interest suspended in a fluid. In this manner, the patterned electric and/or magnetic fields generated by the IC chip can trap and move biological cells or other objects being viewed inside the microfluidic system.

Other embodiments of the present disclosure are directed to sensing/imaging Methods and apparatus utilizing one of the IC-based magnetic and/or electric field generating arrays as introduced above, or other arrangements of magnetic and/or electric field-generating devices. For example, in various aspects of these sensing embodiments, a microcoil array, a micropost array, or other arrangement of field-generating devices (e.g., see the various structures described in PCT Application No. PCT/US02/36280, filed Nov. 5, 2002, entitled “System and Method for Capturing and Positioning Particles,” International Publication No. WO 03/039753 A1) may be controlled using signals of various frequencies so as to be capable of detecting one or more cells, particles or objects of interest, and even the type of particle or object of interest, by measuring resonance characteristics associated with interactions between samples and one or more of the field-generating devices.

In one embodiment, a programmable hybrid system for use with a microscope according to the present disclosure may be implemented using a relatively simple microfluidic system having only a single chamber (a “bathtub”) integrated with a semiconductor-based system that provides programmable and independently controllable electromagnetic fields. In this implementation, cells may be moved through the chamber along virtually any path under computer control of the electromagnetic fields. In this manner, the topology of a “virtual micro-scale plumbing system” for samples of interest may be flexibly changed for a wide variety of operations based on the programmability afforded by computer control. This provides an extremely powerful tool for precision cell/object manipulation in both relatively simple and more sophisticated operations.

In sum, one embodiment according to the present disclosure is directed to a microscope, comprising at least one optic for facilitating viewing of at least one sample suspended in a fluid. The microscope further comprises a plurality of CMOS fabricated field-generating components, a microfluidic system configured to contain the fluid in proximity to the plurality of CMOS fabricated field-generating components, and at least one controller configured to control the plurality of CMOS fabricated field-generating components to generate at least one electric or magnetic field having a sufficient strength to interact with the at least one sample suspended in the fluid.

Another embodiment according to the present disclosure is directed to a method, comprising acts of viewing at least one sample suspended in a fluid through at least one optic, and generating at least one electric or magnetic field from a plurality of CMOS fabricated field-generating components, the at least one electric or magnetic field having a sufficient strength to interact with the at least one sample suspended in the fluid contained in a microfluidic system in proximity to the plurality of CMOS fabricated field-generating components.

The following references are incorporated herein by reference:

PCT Publication No. WO 05/099419, filed Apr. 13, 2005, entitled “Methods and Apparatus for Manipulation and/or Detection of Biological Samples and Other Objects;”

PCT Publication No. WO 05/011101, filed Jul. 19, 2004, entitled “Methods and Apparatus Based on Coplanar Striplines;” and

PCT Publication No. WO 03/039753, filed Nov. 5, 2002, entitled “System and Method for Capturing and Positioning Particles.”

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1A is a diagram illustrating a conventional compound microscope.

FIG. 1B is a diagram illustrating a microscope including a semiconductor-based/microfluidic hybrid system according to one embodiment of the present disclosure.

FIG. 1C is a block diagram showing an overview of various components of the semiconductor-based/microfluidic hybrid system indicated in FIG. 1B, according to one embodiment of the present disclosure.

FIG. 2 illustrates an exemplary physical arrangement of components for the hybrid system shown in FIG. 1C, according to one embodiment of the present disclosure.

FIG. 3(a) is a conceptual perspective illustration of a microcoil array that may be employed as field-generating components in the hybrid system shown in FIGS. 1C and 2, according to one embodiment of the present disclosure.

FIG. 3(b) shows a conceptual illustration of a top (overhead) view of a portion of the array shown in FIG. 3(a), looking down to the array through a portion of a microfluidic channel that contains a liquid in which are suspended exemplary samples comprising a magnetic bead attached to a cell, according to one embodiment of the present disclosure.

FIG. 4 shows a microcoil array similar to that shown in FIG. 3(a) and various field control components associated with the array, according to one embodiment of the present disclosure.

### DETAILED DESCRIPTION

Following below are more detailed descriptions of various concepts related to, and embodiments of, microscopy methods and apparatus according to the present disclosure for one or more of manipulation, detection, imaging, and characterization of biological or other materials viewed with a microscope. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

I. System Overview

One embodiment of the present disclosure is directed to a microscope equipped with a semiconductor-based/microfluidic hybrid system that combines the power of microelectronics with the biocompatibility of a microfluidic system. In some examples below, the microelectronics portion of the hybrid system is implemented in CMOS technology for purposes of illustration. It should be appreciated, however, that the disclosure is not intended to be limiting in this respect, as other semiconductor-based technologies may be utilized to implement various aspects of the microelectronics portion of the systems discussed herein.

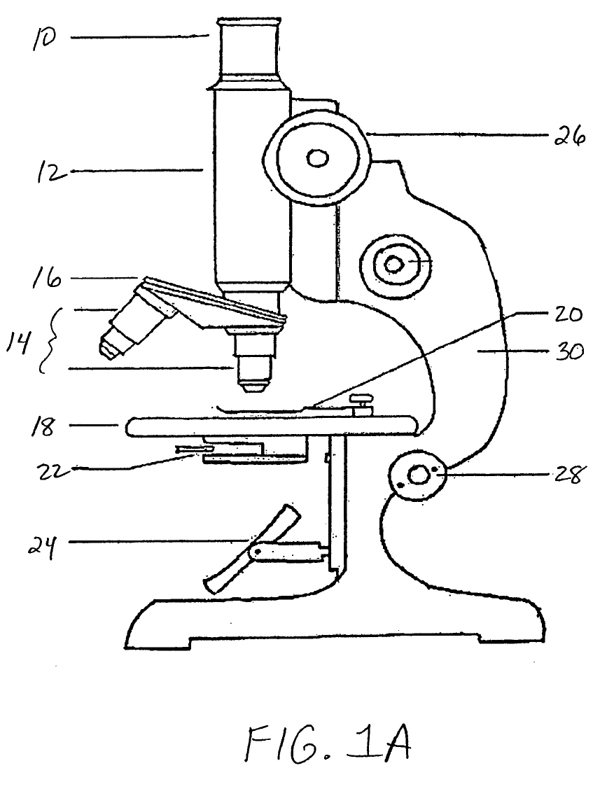

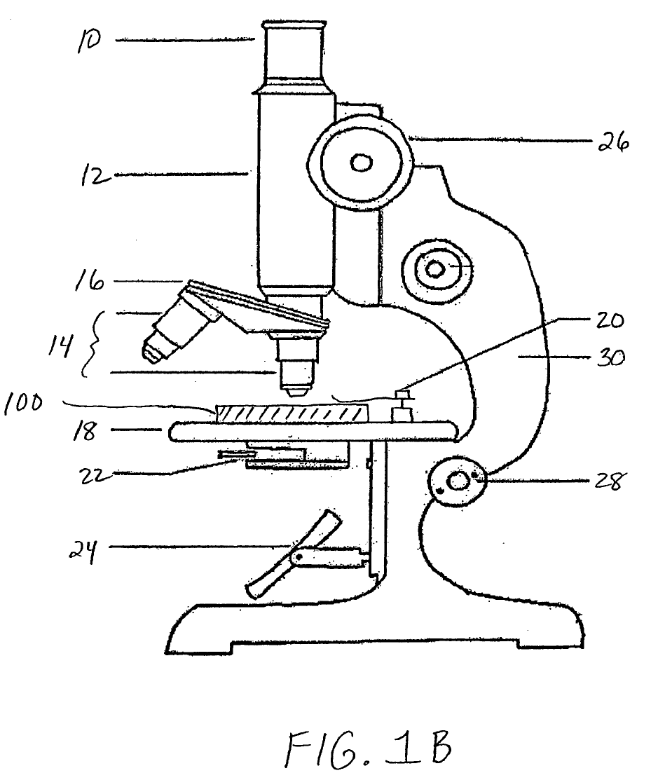

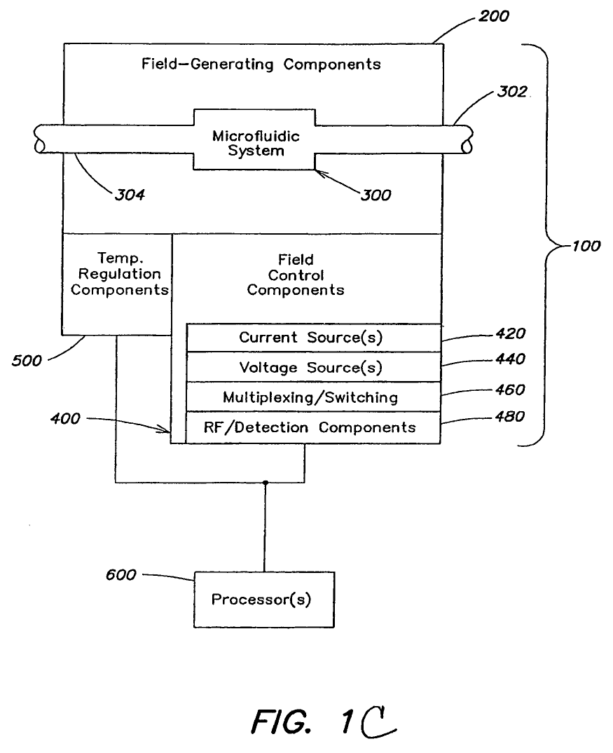

FIG. 1B illustrates a microscope according to one embodiment of the present disclosure equipped with a semiconductor-based/microfluidic hybrid system 100 that is configured to facilitate at least manipulation of samples of interest being viewed with the microscope. In one aspect of this embodiment, the hybrid system 100 may be fabricated in a form (discussed further below) that facilitates affixing the hybrid system 100 in a relatively straightforward manner to the stage 18 of the microscope (e.g., via the sample holder 20). While not shown in FIG. 1B, one or more electrical connections (via wired or wireless techniques) may be provided to the hybrid system 100 to facilitate control of the system to implement sample manipulation and other optional functions.

In another embodiment of a microscope similar to that shown in FIG. 1B, the stage 18 itself may be fabricated such that all or part of the hybrid system 100 forms an integral (i.e., non-removable) part of the stage. For example, in one embodiment, a complete hybrid system as discussed in further detail below may be integrated with the stage 18. In yet other embodiments, only a portion of the system 100, for example electric and/or magnetic field generating components and associated control electronics (see FIG. 1C, reference numbers 200 and 400), may be integrated with the microscope stage 18, while one or more other portions of the system 100, for example a microfluidic subsystem (see FIG. 1C, reference number 300), may be secured in some fashion to a surface of the stage 18. It should be appreciated from the foregoing that the implementation of sample manipulation concepts in a microscope according to the present disclosure for viewing samples of interest may be accomplished in a variety of ways.

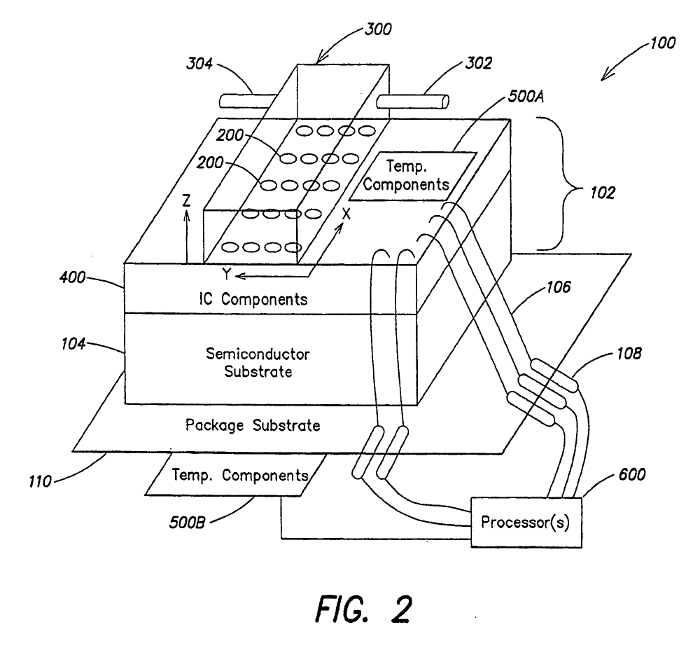

FIG. 1C is a block diagram showing a general overview of various components of a semiconductor-based/microfluidic hybrid system 100, and FIG. 2 illustrates an exemplary physical arrangement of components for such a system, according to one embodiment of the present disclosure. As illustrated in FIGS. 1C and 2, the hybrid system 100 comprises a microfluidic system 300 for holding liquids containing objects (e.g., “samples”) of interest. The hybrid system also includes a number of other components, including electric and/or magnetic field-generating components 200, field control components 400, and temperature regulation components 500. In general, these other components may be employed to facilitate manipulation (e.g., trapping and/or moving), detection, imaging and/or identification of samples via electric and/or magnetic fields, including biological samples requiring regulation of environmental conditions (e.g., temperature).

In one aspect of this embodiment, as shown in FIG. 2, some or all of these other components of the hybrid system 100 may be implemented as one or more integrated circuit (IC) chips 102 using various semiconductor fabrication techniques. For example, FIG. 2 illustrates that various field-generating components 200, field control components 400, and temperature components 500 may be fabricated on a semiconductor substrate 104, pursuant to any of a variety of semiconductor fabrication techniques, .to form an IC chip 102. As mentioned above and discussed in greater detail below, one exemplary implementation of such an IC chip may be fabricated using standard CMOS protocols. The IC chip 102 further may be mounted on a package substrate 110, and bonding wires 106 and contacts (e.g., pins) 108 may be employed to facilitate electrical connections to the IC chip 102. In one embodiment discussed further below, the field control components 400 also may include various components to facilitate wireless communication of data and control signals to and from the IC chip 102.

FIGS. 1C and 2 also illustrate one or more processors 600 configured to control the various components of the hybrid system 100 to facilitate manipulation of samples contained in (or flowing through) the microfluidic system 300. The one or more processors 600 also may be configured to perform various signal processing functions to facilitate one or more of detection, imaging and identification of samples. It should be appreciated that in various configurations, the one or more processors 600 may be implemented as separate components from the hybrid system 100, and optionally located remotely from the hybrid system, as shown in FIG. 2 (e.g., a variety of conventional computing apparatus may be coupled to the hybrid system via one or more contacts 108, or via wireless communications). Alternatively, some or all of the processor functionality may be implemented by elements integrated together with other components in one or more IC chips 102 that form part of the hybrid system 100.

In the hybrid system 100, according to one embodiment, the microfluidic system 300 may be configured as a relatively simple chamber or reservoir for holding liquids containing samples of interest. For example, as illustrated generically in FIGS. 1C and 2, a microfluidic reservoir having an essentially rectangular volume may include access conduits 302 and 304 to facilitate fluid flow into and out of the reservoir. Alternatively, the microfluidic system may have a more complex arrangement including multiple conduits or channels in which liquids containing samples may flow, as well as various components (e.g., valves, mixers) for directing flow. In various embodiments, the microfluidic system 300 may be fabricated on top of an IC chip 102 containing other system components, once the semiconductor fabrication processes are completed, to form the hybrid system 100; alternatively, the microfluidic system 300 may be fabricated separately (e.g., using soft lithography techniques) and subsequently attached to one or more IC chips containing other system components to form the hybrid system 100.

In other aspects of the embodiment shown in FIG. 1C, the electric and/or magnetic field-generating components 200 of the hybrid system 100 may be disposed with respect to the microfluidic system 300 in a variety of arrangements so as to facilitate interactions between generated fields and samples contained in (or flowing through) the microfluidic system. In various implementations, the field-generating components 200 may be disposed proximate to the microfluidic system along one or more physical boundaries of the microfluidic system and arranged so as to permit field-sample interactions along one or more spatial dimensions relative to the microfluidic system.

For example, in one implementation, as illustrated in FIG. 2, the microfluidic system 300 may be configured as an essentially rectangular-shaped reservoir above an IC chip 102 that contains a two-dimensional array of field-generating components 200 disposed in a plane proximate to and essentially parallel to a floor of the reservoir. Such an arrangement facilitates manipulation of samples generally along two dimensions defining a plane parallel to the floor of the reservoir (indicated by x-y axes in FIG. 2). In another implementation, field-generating components may alternatively or additionally be disposed along one or more sides of such a reservoir to facilitate manipulation of samples along a third dimension transverse (e.g., perpendicular) to the floor of the reservoir (indicated by a z axis in FIG. 2). In yet another implementation, a reservoir may be “sandwiched” between two arrays of field-generating components respectively contained in IC chips disposed above and below the reservoir. In such an arrangement, the multiple arrays of field-generating components may be controlled such that three-dimensional manipulation of samples may be accomplished. Additionally, various arrangements of field-generating components with respect to the microfluidic system may facilitate rotation of samples.

It should be appreciated that the foregoing exemplary arrangements are provided primarily for purposes of illustration, and that a variety of arrangements of a microfluidic system and field-generating components (including linear or two-dimensional arrays of field-generating components, or other arrangements of discrete field generating components) are contemplated according to other embodiments to provide multi-dimensional manipulation of samples. In general, according to the various concepts discussed herein, samples of interest may be moved through the microfluidic system along virtually any path, trapped or held at a particular location, and in some cases rotated, under computer control of the electric and/or magnetic fields generated by the field-generating components 200. In this mariner, the topology of a “virtual micro-scale plumbing system” for samples of interest may be flexibly changed for a wide variety of operations based on the programmability and computer control afforded, for example, by the processor(s) 600. This provides an extremely powerful tool for precision cell/object manipulation in both relatively simple and more sophisticated operations.

In various embodiments of the hybrid system 100 shown in FIGS. 1C and 2, the field-generating components 200 may be configured to generate electric fields, magnetic fields, or both. For example, in one embodiment, the field-generating components are configured and operated to produce controllable spatially and/or temporally variable magnetic fields that extend into the microfluidic system. The magnetic fields thusly generated interact with magnetic samples suspended inside the microfluidic system, examples of which include, but are not limited to, biological cells attached to magnetic beads (“bead-bound cells”). With respect to biological samples, it is noteworthy that the magnetic fields do not damage cells; rather, as discussed above, cell manipulation and identification via magnetic fields is a commonly used technique to molecularly identify a biological cell by a specific, ligand-coated magnetic bead. As discussed in further detail below, the interaction between the spatially and/or temporally variable magnetic fields and bead-bound cells or other magnetic samples enables trapping, transport, detection and imaging of single or multiple magnetic samples.

Examples of magnetic field-generating components 200 that may be included in the hybrid system 100 shown in FIGS. 1C and 2 include, but are not limited to, a two-dimensional microelectromagnet wire matrix, as well as one or more “ring traps.” These exemplary components are discussed in detail in PCT Application No. PCT/US02/36280, filed Nov. 5, 2002, entitled “System and Method for Capturing and Positioning Particles,” International Publication No. WO 03/039753 A1, incorporated herein by reference. Yet other examples of devices that may serve as magnetic field-generating components in the hybrid system shown in FIGS. 1C and 2 include micro-scale magnets configured as coils, or “microcoils.” Some examples of microcoils including ferromagnetic cores and fabricated using micromachining techniques are given in U.S. Pat. Nos. 6,355,491 and 6,716,642, as well as International Application Publication No. WO00/54882, each of which publications is incorporated herein by reference. Yet another example of magnetic field-generating components according to one embodiment of the present invention includes a CMOS microcoil array and associated control circuitry. Further details of such a CMOS microcoil array are discussed below in Section II.

It should be appreciated that for virtually any hybrid system 100 according to the present disclosure based on a microelectronics portion configured to generate controllable spatially and/or temporally variable magnetic fields, a parallel implementation may be realized using configurations for generating controllable spatially and/or temporally variable electric fields, or a combination of variable magnetic fields and variable electric fields.

For example, in one embodiment, the field-generating components 200 of the hybrid system shown in FIGS. 1C and 2 may include an array of microelectrodes, or “microposts,” configured to generate controllable electric fields for manipulating -objects of interest according to principles of dielectrophoresis. As discussed above, dielectrophoresis occurs when an inhomogeneous electric field induces a dipole on a particle suspended in liquid. The subsequent force on the dipole pulls the particle to either a minimum or a maximum of the electric field. Almost any particle, without any special preparation, can be trapped or moved using dielectrophoresis when it is exposed to the proper local electric field. In this manner, according to one embodiment, one or more samples of interest suspended in liquid in the microfluidic system 300 may be manipulated via operation of a micropost array serving as the field-generating components 200 to generate electric fields appropriate for this task.

As mentioned above and also shown in FIG. 1C, the field control components 400 of the hybrid system 100 may include one or more current sources 420 to facilitate the generation of magnetic fields from magnetic field-generating components, according to some embodiments of the invention. Similarly, the field control components may also, or alternatively, include one or more voltage sources 440 to facilitate the generation of electric fields from electric field-generating components, according to other embodiments of the invention.

In general, whether the field control components 400 include one or more current sources 420, one or more voltage sources 440, or both, according to one embodiment the field control components also include various switching or multiplexing components 460 to facilitate the appropriate application of currents and/or voltages to individual field-generating components or groups of field-generating components. In various implementations discussed in greater detail below, the switching or multiplexing components 460 may be configured as a programmable digital switching network (e.g., under control of the one or more processors 600) such that the output(s) of one or more current and/or voltage sources are applied in a prescribed independently controllable manner to the field-generating components, so as to create the spatially and/or temporally patterned electric and/or magnetic fields that facilitate sample manipulation.

As also shown in FIG. 1C, the field control components 400 additionally may include radio frequency (RF) and other detection components 480, coupled between the field-generating components 200 and the one or more processors 600, for facilitating one or more of detection, imaging and characterization of samples contained in the microfluidic system 300, according to various embodiments of the present disclosure. In different aspects, examples of such RF/detection components 480 may include, but are not limited to, oscillators, mixers and/or filters, which are operated (e.g., under control of the one or more processors 600 via the switching or multiplexing components 460) to both generate RF fields from the field-generating components and measure signals indicating some type of interaction between the generated RF fields and one or more samples of interest.

In general, as is well known based on Maxwell's Equations, an RF field is capable of interacting with virtually any particle (biological or otherwise) that conducts electricity at the RF signal frequency, or is polarizable electrically or magnetically. Accordingly, in various embodiments of the present disclosure, the interaction between RF electric and/or magnetic fields and samples of interest may be exploited not only to move samples but also to determine the position of the sample (e.g., to facilitate imaging). Moreover, spectral responses arising from the RF field/sample interaction may be used in some cases to identify or characterize different types or classes of samples.

For example, conducting samples have circulating currents induced by an RF field that in turn produce their own magnetic field, and interact strongly with an applied field. This is the basis of operation of conventional electric motors (e.g., a “squirrel cage” rotor with no electrical contacts). This interaction can be used to move samples and also detect their presence. In one mechanism discussed in greater detail below, magnetic polarization of a sample changes the inductance of a coil (e.g., a microcoil of an array) in proximity to the sample; accordingly, damping of oscillations of the magnetic polarization causes detectable losses in a circuit including the microcoil. In yet another example, electrical polarization of a sample gives rise to the forces responsible for dielectrophoresis (DEP). This polarization can be detected via a change in capacitance between the sample and the electrodes of an electric-field generating device (e.g., a micropost or microcoil with an applied voltage) with no dissipation, or by a change in damping due to the oscillating electric polarization in the sample. The foregoing examples provide various mechanisms by which the location of a sample can be detected, and thus imaged.

Based on such RF imaging techniques, various implementations of a hybrid system according to the present disclosure may incorporate feedback control mechanisms, whereby samples of interest may be manipulated based on acquired images of the samples. For example, in one embodiment, the hybrid system may be programmably configured (e.g., via the one or more processors 600) to first obtain an image of a distribution of samples contained in the microfluidic system. Thereafter, based on the imaged distribution, one or more particular samples may be manipulated based on a prescribed algorithm.

Various concepts disclosed herein relating to RF fields likewise may be employed for identification and characterization of samples of interest. For example, frequency dependent changes in either the electric or magnetic polarization of samples can be used to identify the type of sample, using knowledge of the behavior of various materials in electromagnetic fields from conventional solid state physics. These changes may be characterized over a broad range of frequencies. Accordingly, in one embodiment, by sweeping the RF frequency of signals applied to field-generating components (or using more sophisticated signal processing techniques), the frequency response (e.g., absorption spectrum) of the sample can be measured at a particular location, and the sample may be identified or characterized based on the measured response.

In yet other embodiments relating to the application of RF fields and sensing of field/sample interactions under the control of the RF/detection components 480, an RF field can be used to conduct local measurements of magnetic resonance in a uniform magnetic field applied to a sample. In particular, the spins or magnetic domains of a given sample oscillate with characteristic frequencies, which can be used to identify the type of spin or the sample itself. Magnetic resonance types include ferromagnetic resonance (FMR) (small YIG spheres can be used as magnetic beads, wherein a YIG sphere has a single magnetic domain that rotates freely at GHz frequencies because the bead is spherical). Additionally, Electron Spin Resonance (ESR) techniques may be employed to identify the g-factor of the spins involved to characterize their origin (i.e., the sample), as well as Nuclear Magnetic Resonance (NMR) to identify the g-factors of the nuclear spins. Thus, according to the principles discussed herein, a Magnetic Resonance Imaging (MRI) system may be implemented on a chip.

While not explicitly shown in FIGS. 1C and 2, according to various embodiments the field control components 400 also may include one or more analog to digital (A/D) and digital to analog (D/A) converters to facilitate the communication of various data and signals amongst other field control components, as well as to and from the IC chip 102. The field control components also may include digital signal processing components and signal amplification components to facilitate processing and transport of signals. Furthermore, the field control components may include a wireless transceiver and an antenna to facilitate wireless communication to and from the IC chip 102. In one exemplary wireless implementation, the ISM radio bands (free, non-commercial radio bands allowed for industrial, scientific and medical purposes) may be utilized for wireless communications between the IC chip 102 and a remote user or control interface (e.g., the one or more processors 600). Present wireless transceiver technology allows miniature, low-power transceivers to transmit and receive data at high data rates (e.g., several kilobits or megabits per second), which is sufficient for the reliable transfer of information to and from the IC chip 102.

Finally, FIGS. 1C and 2 also illustrate that the hybrid system 100 may include temperature regulation components 500 to facilitate biocompatibility of the hybrid system. For example, according to one embodiment, the temperature of the system may be regulated at or near a particular temperature to facilitate biocompatibility of the system with the samples under investigation. In one exemplary implementation, the temperature regulation components may include one or more “on-chip” temperature sensors 500A (e.g., in proximity to the microfluidic system 300, as shown in FIG. 2) and an “off-chip” temperature controller 500B (e.g., a thermoelectric or “TE” cooler attached to the package substrate 110, as shown in FIG. 2). In one aspect, the one or more on-chip temperature sensors 500A sense the temperature of the IC chip in proximity to the microfluidic system and the one or more processors 600 compare the measured temperature to a reference temperature (e.g., 37° C.). The one or more processors in turn send an appropriate feedback control signal to the off-chip temperature controller 500B, which heats up or cools down the whole substrate accordingly.

Having provided a general overview of a hybrid system for a microscope and microscopy methods according to the present disclosure for manipulation, detection, imaging and characterization of samples using electromagnetic fields, more detailed descriptions of various concepts related to different portions of the hybrid system are set forth below. Various concepts relating to such hybrid systems also are discussed in PCT published application WO 05/099419, published Dec. 1, 2005, which publication is hereby incorporated by reference.

II. Microcoil Array

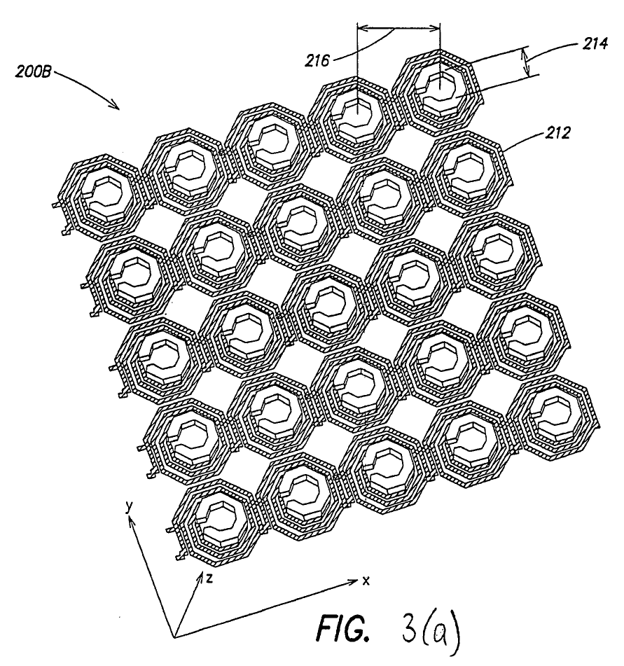

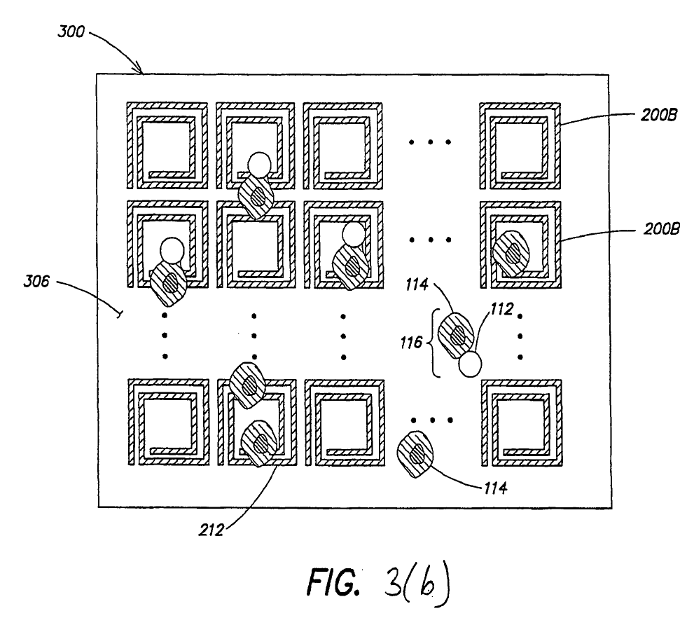

FIG. 3(a) is a conceptual perspective illustration of a microcoil array 200B that may be employed as field-generating components 200 in the hybrid system 100 shown in FIGS. 1C and 2, according to one embodiment of the present disclosure. In the example of FIG. 3(a), the array 200B includes five columns and five rows of essentially identical microcoils 212. Although FIG. 3(a) illustrates a five-by-five microcoil array, it should be appreciated that microcoil arrays according to various embodiments of the invention are not limited in this respect, and may have different numbers of microcoils and different geometric arrangements.

A microcoil array 200B similar to that shown in FIG. 3(a) may be configured and controlled to facilitate the manipulation of magnetic samples contained in the microfluidic system 300, including cells coupled to magnetic beads. FIG. 3(b) shows a conceptual illustration of a top (overhead) view of a portion of the array 200B shown in FIG. 3(a), looking down to the array through a portion of a microfluidic system 300 (e.g., a channel) that contains a liquid 306 in which are suspended exemplary samples 116 comprising a magnetic bead 112 attached to a cell 114 (i.e., a bead-bound cell). The liquid 306 also may contain one or more cells 114 that are not attached to a magnetic bead. In one embodiment, to manipulate the bead-bound cells 116 (or other types of magnetic samples), each microcoil 212 of the array 200B is independently connectable to a source of controllable current. Thus, by independently controlling the magnitude of current flowing through each microcoil, various magnetic field patterns can be generated in proximity to the microcoil array 200B and employed to trap and otherwise manipulate magnetic samples. Further design specifics of microcoil arrays suitable for purposes of the present disclosure may be found in PCT published application WO 05/099419, which is incorporated by reference herein.

As discussed above in connection with FIGS. 1C and 2, in one embodiment various field control components 400 for controlling and distributing current (and/or voltage) to the microcoils of the array 200B may be integrated together with the array in an IC chip 102. In one exemplary implementation, these field control components include one or more current sources (and/or voltage sources), as well as various switching or multiplexing components to facilitate digital (and computer programmable) control of the fields generated by the array 200B.

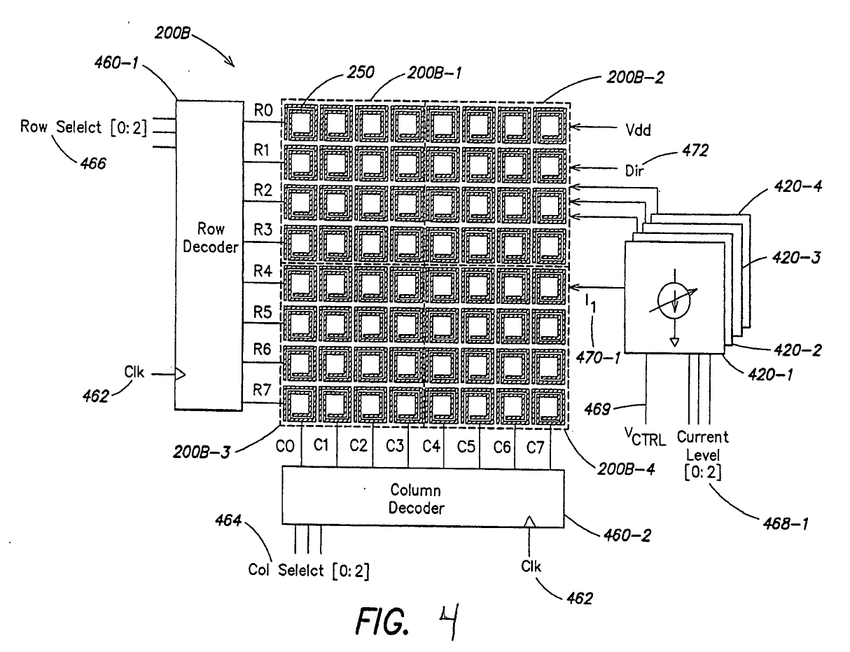

FIG. 4 is a diagram showing the microcoil array 200B and various field control components associated with the array 200B, according to one embodiment of the present disclosure. In the example of FIG. 4, the array 200B includes eight rows and eight columns of “microcoil cells” 250, wherein each microcoil cell includes a microcoil 212, as well as switches and logic circuits. For purposes of distributing current (and/or voltage) to the microcoil cells 250, the array 200B of this embodiment is divided into four quadrants 200B-1, 200B-2, 200B-3 and 200B-4, each quadrant having sixteen microcoil cells 250 (i.e., four rows and four columns per quadrant). It should be appreciated, however, that microcoil arrays and associated control components according to the present disclosure are not limited in this respect, and that the particular configuration shown in FIG. 4 is provided primarily for purposes of illustration.

As shown in FIG. 4, the various field control components associated with the array 200B in this embodiment include a row decoder 460-1 that provides row enable signals R0-R7 to respective rows of the array 200B, and a column decoder 460-2 that provides column enable signals C0-C7 to respective columns of the array. The row decoder receives as inputs three digital row select signals 466 (Row Select [0:2]) coded in binary to generate a desired one of the row enable signals R0-R7 at any given time. Similarly, the column decoder receives as inputs three digital column select signals 464 (Column Select [0:2]) coded in binary to generate a desired one of the column enable signals C0-C7 at any given time. Both the row decoder 460-1 and the column decoder 460-2 receive a common clock signal 462 (Clk) that serves to synchronize the generation of a given row enable signal and a given column enable signal so as to select a particular one of the microcoil cells 250 at a given time. In one exemplary implementation, the clock signal 462, row select signals 466 and column select signals 464 are provided by one or more processors 600, as discussed above in connection with FIGS. 1C and 2, such that these signals may be generated pursuant to programmable and/or user-selected computer control.

FIG. 4 also conceptually illustrates four variable current sources 420-1, 420-2, 420-3 and 420-4 that provide a controllable variable current to the microcoil cells 250 of the array 200B. An exemplary one of the four current sources, namely variable current source 420-1, is shown as configured to receive three digital current level signals 468-1 (Current Level [0:2]) and a control voltage 469 (V_{CTRL}), and provide as an output to the array a controllably variable current 470-1 (I₁). In one embodiment, the variable current source 420-1 is configured to provide one of eight different currents based on the digital binary coded current level signals 468-1 and a voltage of the control voltage V_{CTRL}. In the configuration of FIG. 4, while not explicitly indicated in the figure, each of the other current sources 420-2, 420-3, and 420-4 also receive as inputs three binary coded digital current level signals and the control voltage V_{CTRL}, and provides a corresponding variable current output having eight different possible current levels. In one aspect of this embodiment, the digital current level signals for each of the variable current sources may be provided by one or more processors 600, as discussed above in connection with FIGS. 1C and 2, such that these signals may be generated pursuant to programmable and/or user-selected computer control.

Finally, FIG. 4 also illustrates that the array 200B of this embodiment receives a DC power supply voltage Vdd common to all of the microcoil cells 250 of the array, as well as a “direction” signal 472 (Dir), also common to all of the microcoil cells 250, that determines the direction (polarity) of current flowing through the microcoils of each microcoil cell 250.

In one aspect of the embodiment of FIG. 4, the variable current sources are configured with respect to the microcoil cells such that each current source provides current to all of the microcoils in one quadrant of the array. For example, in one implementation, the current source 420-1 provides current to the microcoils of the first quadrant 200B-1, the current source 420-2 provides current to the second quadrant 200B-2, the current source 420-3 provides current to the third quadrant 200B-3, and the current source 420-4 provides current to the fourth quadrant 200B-4. In this configuration, each quadrant of the array 200B operates in a substantially similar fashion.

In the embodiment of FIG. 4, various field control components, including variable current sources, switching and multiplexing components, logic gates, and the like, are employed as a “digital switching network” that effectively controls and distributes current in the microcoil array 200B. In one aspect of these embodiments, such a digital switching network makes control of the array 200B more practicable, especially in implementations in which the number (N²) of microcoil cells 250 may be significantly large; more specifically, current may be time-shared in a multiplexed manner amongst multiple microcoils, and a relatively small number of digital signal inputs may be employed to control the entire microcoil array. With reference again to FIG. 4, again the signals required in this embodiment to provide for array control and facilitate sample manipulation include a clock signal 462, three column select signals 464, three row select signals 462, twelve current level signals (i.e., three signals for each of four variable current sources, as indicated by the signals 468-1 for one of the current sources), a control voltage 469 (V_{CTRL}) for the current sources, and a direction (polarity) signal 472. As discussed above, any one or all of the foregoing signals may be provided by one or more processors 600, as shown in FIGS. 1C and 2, such that these signals may be generated pursuant to programmable and/or user-selected computer control.

In general, it should be appreciated that the configuration of current sources and microcoils illustrated in FIG. 4 and the multiplexing technique described above are provided as an exemplary implementation, and that other configurations according to the present disclosure are possible. For example, in alternative configurations, the array 200B may be subdivided into greater or fewer subdivisions (e.g., four microcoil cells per subdivision instead of sixteen), wherein a variable current having a predetermined number of different current levels for each subdivision is provided by one current source dedicated to the subdivision. Alternatively, in another implementation, only one such current source may provide current to all the microcoil cells of the array 200B in a sequential time-shared (e.g., multiplexed) manner. In yet another configuration, each microcoil cell may be equipped with its own variable current source, such that there is no need to multiplex one current source amongst multiple microcoils. In general, any implementation that makes use of a current-sharing scheme by using one current source to provide current to multiple microcoils reduces DC power dissipation from the system.

It should also be appreciated that while the exemplary concepts discussed above in connection with FIG. 4 focus on microcoils driven by current sources, alternative implementations of field-generating arrays for sample manipulation based on the general switching and multiplexing architecture outlined in FIG. 4 may be based on electric-field generation and dielectrophoresis principles using microcoils or microposts driven by voltage sources.

III. Sample Detection, Imaging and Characterization

As discussed above in Section I, with reference again to FIG. 1C, the field control components 400 of a semiconductor-based/microfluidic hybrid system additionally may include radio frequency (RF) and other detection components 480, coupled between the field-generating components 200 and the one or more processors 600, for facilitating one or more of detection, imaging and characterization of samples contained in the microfluidic system 300, according to various embodiments of the present disclosure. In different aspects, the RF/detection components 480 are configured to facilitate both the generation of electromagnetic fields from the field-generating components based on relatively high frequency (e.g., RF, microwave) electric signals (voltages or currents), as well as the measurement of signals indicating some type of interaction between the generated RF fields and one or more samples of interest.

In general, as is well known based on Maxwell's Equations, an RF field is capable of interacting with virtually any particle (biological or otherwise) that conducts electricity at the RF signal frequency, or is polarizable electrically or magnetically. Accordingly, in various embodiments of the present disclosure, the interaction between RF electric and/or magnetic fields and samples of interest may be exploited not only to move samples as discussed above in Section II, but also to determine the position of the sample (e.g., to facilitate imaging).

For example, conducting samples have circulating currents induced by an RF field that in turn produce their own magnetic field, and interact strongly with an applied field. This interaction can be used to move samples and also detect their presence. In one mechanism, magnetic polarization of a sample changes the inductance of a coil (e.g., a microcoil of an array) in proximity to the sample and, in turn, this inductance change can be detected using high frequency signals. In yet another example, electrical polarization of a sample gives rise to the forces responsible for dielectrophoresis (DEP). This polarization can be detected via a change in capacitance between the sample and the electrodes of an electric-field generating device (e.g., a micropost or microcoil with an applied voltage) with no dissipation, or by a change in damping due to the oscillating electric polarization in the sample.

The foregoing examples provide various mechanisms by which the location of a sample can be detected. Based on the capability to detect the position of a sample relative to a given field generating component, in one embodiment each of the field generating components 200 is analogous to an imaging pixel (e.g., consider a two-dimensional CCD array) that provides valuable information toward constructing a comprehensive image of a sample distribution suspended in a microfluidic system. In another embodiment, images of sample distributions in turn may be used as feedback to manipulate one or more samples according to a prescribed algorithm.

Having discussed the detection of a magnetic sample, various concepts disclosed herein relating to RF fields likewise may be employed for identification and characterization of samples of interest. For example, frequency dependent changes in either the electric or magnetic polarization of samples can be used to identify the type of sample, using knowledge of the behavior of various materials in electromagnetic fields from conventional solid state physics. These changes may be characterized over a broad range of frequencies. Accordingly, in one embodiment, by sweeping the RF frequency of signals applied to field-generating components (or using more sophisticated signal processing techniques), the frequency response (e.g., absorption spectrum) of the sample can be measured at a particular location, and the sample may be identified or characterized based on the measured response.

In yet other embodiments relating to the application of RF fields and sensing of field/sample interactions under the control of the RF/detection components 480, an RF field can be used to conduct local measurements of magnetic resonance in a uniform magnetic field applied to a sample. In particular, the spins or magnetic domains of a given sample oscillate with characteristic frequencies, which can be used to identify the type of spin or the sample itself. Magnetic resonance types include ferromagnetic resonance (FMR) (small YIG spheres may be used as magnetic beads, as each sphere has a single magnetic domain that rotates freely at GHz frequencies because the bead is spherical). Additionally, Electron Spin Resonance (ESR) techniques may be employed to identify the g-factor of the spins involved to characterize their origin (i.e., the sample), as well as Nuclear Magnetic Resonance (NMR) to identify the g-factors of the nuclear spins. Thus, according to the principles discussed herein, a Magnetic Resonance Imaging (MRI) system may be implemented on a chip.

IV. Temperature Regulation

As mentioned above in connection with FIGS. 1C and 2, according to one embodiment the hybrid system 100 may include temperature regulation components 500. In exemplary implementations involving a significant number of field generating components 200 and accompanying field control components 400, the power consumption of the system may be appreciable and operation of these components may increase the temperature in and around the system. In view of the foregoing, the temperature of the system may be regulated at or near a particular temperature to facilitate biocompatibility of the system with the cells/samples under investigation, and also to reduce the risk of electromigration failure as mentioned earlier.

More specifically, according to one embodiment, the temperature regulation components 500 may include one or more on-chip temperature sensors 500A and an off-chip temperature controller 500B. With reference for the moment again to FIG. 2, in various implementations multiple on-chip temperature sensors 500A may be disposed at a variety of locations in and around the IC chip 102; in FIG. 2, one exemplary temperature sensor 500A is illustrated generally in the environment of the IC chip 102, which is in turn coupled to the package substrate 110. In one aspect of this embodiment, the one or more on-chip sensors 500A provide one or more temperature signals to the processor 600, which in part may be configured to implement the function of a comparator that compares the temperature signal(s) to a reference temperature signal (in one exemplary implementation, the reference temperature signal may represent a temperature of 37 degrees C.).

In various implementations, the processor 600 may be configured to receive multiple temperature signals from respective different on-chip sensors, and process the multiple signals according to one or more predetermined algorithms (e.g., averaging, weighted averaging based on chip location, etc.) to provide some aggregate sensed temperature value, which then may be compared to the reference temperature. Based on a comparison of one or more sensed temperatures and the reference temperature, a control signal is provided to the off-chip temperature controller 500B, which heats up or cools down the package substrate 110 accordingly (e.g., a thermoelectric or “TE” cooler may be used as the off-chip controller 500B in one exemplary implementation). In another aspect of this embodiment, the thermal conductivity across all the layers and within each layer of the IC chip 102 is such that the whole system can be assumed to be at the same temperature. Thus, the regulation loop is sufficient to keep the temperature of the overall system at a constant value.

Having thus described illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. A microscope, comprising:
at least one optic to facilitate viewing of at least one sample of interest suspended in a fluid;
a plurality of CMOS fabricated field-generating components;
a microfluidic system configured to contain the fluid in proximity to the plurality of CMOS fabricated field-generating components; and
at least one controller configured to control the plurality of CMOS fabricated field-generating components to generate at least one electric or magnetic field having a sufficient strength to interact with the at least one sample suspended in the fluid.

2. The microscope of claim 1, wherein the at least one controller is configured to control the plurality of CMOS fabricated field-generating components to generate a plurality of programmable spatially or temporally variable electric or magnetic fields having a sufficient strength to interact with the at least one sample suspended in the fluid.

3. The microscope of claim 1, further comprising at least one processor coupled to the at least one controller, the at least one processor configured to control the at least one controller so as to facilitate at least one of manipulation, detection, imaging and characterization of the at least one sample via the generated at least one electric or magnetic field.

4. The microscope of claim 3, wherein the at least one processor is configured to facilitate programmable automated manipulation of the at least one sample based on detection of the at least one sample.

5. The microscope of claim 1, wherein the at least one controller includes a plurality of CMOS fabricated field control components forming an integrated circuit chip together with the plurality of CMOS fabricated field-generating components.

6. The microscope of claim 5, wherein the microfluidic system is coupled integrally with the integrated circuit chip to form a CMOS/microfluidic hybrid system.

7. The microscope of claim 5, wherein the plurality of field control components includes:
a plurality of programmable switching or multiplexing components; and
a plurality of current or voltage sources.

8. The microscope of claim 7, wherein the plurality of field control components further includes a plurality of high frequency detection components configured to facilitate at least one of detection, imaging and characterization of the at least one sample suspended in the fluid via the generated at least one electric or magnetic field.

9. The microscope of claim 8, further comprising at least one CMOS fabricated temperature regulation component forming the integrated circuit chip together with the plurality of CMOS fabricated field control components and the plurality of CMOS fabricated field-generating components.

10. The microscope of claim 1, wherein the plurality of CMOS fabricated field-generating components includes a plurality of microcoils.

11. The microscope of claim 10, wherein the plurality of microcoils are arranged as a two-dimensional array.

12. A microscopy method, comprising acts of:
A) generating at least one electric or magnetic field from a plurality of CMOS fabricated field-generating components, the at least one electric or magnetic field having a sufficient strength to interact with at least one sample suspended in a fluid contained in a microfluidic system in proximity to the plurality of CMOS fabricated field-generating components; and
viewing the at least one sample via at least one optic associated with a microscope.

13. The method of claim 12, wherein the act A) includes an act of:
A1) generating a plurality of programmable spatially or temporally variable electric or magnetic fields having a sufficient strength to interact with the at least one sample suspended in the fluid.

14. The method of claim 13, further comprising an act of:
B) controlling the plurality of electric or magnetic fields so as to facilitate at least one of manipulation, detection, imaging and characterization of the at least one sample.

15. The method of claim 14, wherein the act B) comprises an act of:
controlling the plurality of electric or magnetic fields so as to facilitate automated manipulation of the at least one sample based on detection of the at least one sample.

16. The method of claim 14, wherein the act A1) comprises an act of:
applying a voltage or current to the plurality of CMOS fabricated field-generation components via a plurality of programmable switching or multiplexing components.

17. The method of claim 14, wherein the act A1) comprises an act of:
A2) applying at least one high frequency signal to at least one field-generation component of the plurality of CMOS fabricated field-generation components to facilitate at least one of detection, imaging and characterization of the at least one sample.

18. The method of claim 17, wherein the act A2) comprises an act of:
monitoring a frequency of the at least one high frequency signal, wherein the frequency indicates the presence or absence of the at least one sample in proximity to the at least one field-generation component.

19. The method of claim 12, further comprising an act of:
C) regulating a temperature of the at least one sample.

20. The method of claim 12, wherein the plurality of CMOS fabricated field-generating components includes a plurality of microcoils.
